(19) United States
(12) Patent Application Publication
(10) Pub. No.: US 2019/0331293 A1
(43) Pub. Date: Oct. 31, 2019

(54) Lever Type Grease Gun

(71) Applicant: Shuoxing Metal Products (Kunshan) CO., LTD., Jiangsu (CN)

(72) Inventor: Wen-I KUO, Jiangsu (CN)

(73) Assignee: Shuoxing Metal Products (Kunshan) Co., Ltd.

(21) Appl. No.: 16/431,060

(22) Filed: Jun. 4, 2019

Related U.S. Application Data
(63) Continuation-in-part of application No. 15/962,835, filed on Apr. 25, 2018.

(51) Int. Cl. F16N 3/12

(52) U.S. Cl. CPC F16N 3/12

(57) ABSTRACT

A lever-type grease gun includes: a hollow cylinder having a first end and a second end opposite to the former; a front-end cover located at the first end and provided with a nozzle part and a mounting portion; a back-end cover located at its second end; an oil pushing rod located at the front-end cover, capable of moving in the front-end cover under push forces and closer to the back-end cover than the mounting portion, and having an oil pushing rod part; and a handle unit comprising a lever having a pivoting part to match the mounting portion, a pressing part and a plurality of straight slots between the two and a connecting set inserted in the oil pushing rod part and the straight slots and moving in the straight slots, thus reducing the force required to fill grease.

### BACKGROUND

### Cross Reference to Related Application

This application is a continuation-in-part of U.S. patent application Ser. No. 15/962,835, which claims the earlier filing date of Apr. 25, 2018, the entire specification of which is incorporated herein by reference.

### Field of the Invention

The present invention relates to a grease gun, and more particularly to a lever type grease gun.

### RELATED PRIOR ART

The grease guns disclosed in Chinese patents, for instance, CN2152134Y and CN2536887Y, are hand-operated tools for injecting lubrication grease into mechanical equipment. The known structure for a grease gun 10 shown in FIG. 1 mainly consists of a hollow cylinder 11 for storing grease whose opposite ends are threaded for a front-end cover 12 and a back-end cover 13, wherein the front-end cover 12 extends and is formed with a nozzle 121 while it is provided with an oil pushing rod 14 and a handle unit 15, and a piston rod 16 is inserted into the hollow cylinder 11 through the back-end cover 13. Generally, the back end of the grease gun is always for provision of the piston rod 16, so the grease is filled through the front end of the hollow cylinder 11. The oil pushing rod 14, the piston rod 16 and the handle unit 15 work together to push the grease to and out of the nozzle 121 into the mechanical equipment. However, actually, there are some aspects needing to be improved.

Since the handle unit 15 mainly consists of a link 151 and a lever 152, wherein the first end 1511 of the link 151 is pivoted at the front-end cover 12, the second end 1512 of the link 151 is pivoted at the pivoting part 1521 of the lever 152, and the connecting part 1522 of the lever 152 is pivoted to the oil pushing rod 14 by means of a rivet, and consequently the link 151, the lever 152 and the oil pushing rod 14 are pivoted and the pivoting distances among them do not change during operation, that is, before, during and after pressing the lever 152, the distance L1 between the pivoting part 1521 of the lever 152 as a fulcrum P1 and the connecting part 1522 of the lever 152 as the resistance point P2 as well as the distance L2 between the connecting part 1522 of the lever 152 as the resistance point P2 and the pressing part 1523 of the lever 152 as the point of force application P3 do not change, so it will require the same force to press the pressing part 1523 of the lever 152 to the hollow cylinder 11 during the whole operation of grease filling, clearly showing the disadvantage that strenuous efforts have to be made to operate such a gun.

Referring to FIG. 2A, there is shown a lubrication gun disclosed in U.S. Pat. No. 2,497,762. Since the handle unit also consists of a link 17 and a lever 18, and the link 17, the lever 18 and the oil pushing rod 19 are connected to one another in a pivoting manner. The distance L1 between the pivoting part 181 of the lever 18 as the fulcrum P1 and the connecting part 182 of the lever 18 as the resistance point P2 does not change during operation, that is, before, during and after pressing the lever 18, so it will require the same force to press the lever 18 toward the hollow cylinder 191 during the whole operation of grease filling, clearly showing the disadvantage that strenuous efforts have to be made to operate such a gun. Furthermore, a non-fixed type link 17 is pivotally disposed between the lever 18 and the front-end cover 197, so that the pressing force is relatively unstable. Similarly, referring to FIG. 2B, another operational state of the lubrication gun is shown, the distance L1 between the pivoting part 181 of the lever 18 as the fulcrum P1 and the connecting part 182 of the lever 18 as the resistance point P2 does not change either during the whole greasing filling process, which also requires the same force to press the lever 18 toward the hollow cylinder 191, clearly showing the disadvantage that strenuous efforts have to be made to operate such a gun.

It should be noted that, it can be learned from the second column line 55 to the third column line 49 of U.S. Pat. No. 2,497,762 that, throughout the process of grease filling by pressing the lever 18, the position of the connecting pivot 193 in the arcuate slot 195 is fixed and does not shift from the position of FIG. 2B to that of FIG. 2A, so that the force required for pressing the lever 18 does not gradually decrease before, during, and after pressing the lever 18, which highlights the disadvantage of difficult in operating this lubrication gun. When the connection pivot 193 is in the position of FIG. 2A or FIG. 2B, it is used as a high pressure operation state or a low pressure operation state, however, the connection pivot 193 does not shift along with the pressing of the lever 18 during the process of greasing filling.

The present invention has arisen to mitigate and/or obviate the afore-described disadvantages.

### SUMMARY

One objective of the present invention is to provide a lever-type grease gun capable filling grease with less effort and improved stability.

To achieve the above objective, a lever type grease gun in accordance with the present invention comprises: a hollow cylinder, having a first end and a second end opposite to the first end; a front-end cover, located at the first end of the hollow cylinder and provided with a nozzle part and a mounting portion; a back-end cover located at the second end of the hollow cylinder; an oil pushing rod disposed at the front-end cover, located closer to the back-end cover than the mounting portion, capable of moving in the front-end cover under push forces, and having an oil pushing rod part located outside the front-end cover; and a handle unit comprising a lever and a connecting set, wherein the lever is mounted on the front end cover in a pressable manner, and capable of being pressed from a first position toward a second position, the lever includes: a pivoting part pivotally connected to the mounting portion, a pressing part, and a rod portion between the pivoting part and the pressing part, the rod portion has a bottom surface and a straight slot extending along a length of the lever and having a first slot end and a second slot end which is closer to the pivoting part than the first slot end, the straight slot has an extension line passing through the first and second slot ends, the extension line is parallel to the bottom surface; the connecting set is inserted through the oil pushing rod part, disposed in the straight slot and movable between the first slot end and the second slot end; when the lever is in the first position, the connecting set is located at the first slot end, when the lever is pushed to the second position, the connecting set is moved to the second slot end, while the lever is being pushed to move from the first position to the second position, the connecting set is moved from the first slot end to the second slot end, and a linear distance between the connecting set and the pivoting part gradually decreases.

Preferably, the rod portion further includes two wing surfaces respectively disposed on and connected to two opposite sides of the bottom surface, and each of the wing surfaces is provided with the straight slot, the connecting set includes two connecting shaft sleeves and a connecting pivot, the connecting shaft sleeves are located in the straight slot, and the connecting pivot is inserted through the connecting shaft sleeves, the straight slot and the oil pushing rod part.

The present invention provides a lever type grease gun which has the straight slots formed in the lever of the handle unit, and the extension line of each of the straight slots is parallel to the bottom surface. Besides, with the design that the connecting set is inserted in the oil pushing rod part and movable within the straight slots, the present invention provides a sliding connection between the oil pushing rod and the lever during pressing of the lever, that is, the distance between the pivoting part of the lever as the fulcrum and the connecting set as the resistance point as well as the distance between the connecting set as the resistance point and the pressing part of the lever as the point of force application will change before, during and after pressing of the lever, thus reducing the force required to fill the grease.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a side view of a conventional grease gun;

FIG. 2A is a view of a lubrication gun disclosed in U.S. Pat. No. 2,497,762, showing the state of the lubrication gun in a high pressure press position;

FIG. 2B is a view of a lubrication gun disclosed in U.S. Pat. No. 2,497,762 showing the state of the lubrication gun in a low pressure depressed position;

FIG. 3 is an exploded perspective view of an embodiment of the present invention;

4 is a perspective assembled view of an embodiment of the present invention;

FIG. 5 is a magnified view showing the operation of the embodiment of the present invention, showing the state before the lever is pressed;

FIG. 6 is a magnified view of the operation of the embodiment of the present invention, showing the state in which the lever is pressed; and

FIG. 7 is a magnified view of the operation of the embodiment of the present invention, showing the state after the lever is pressed.

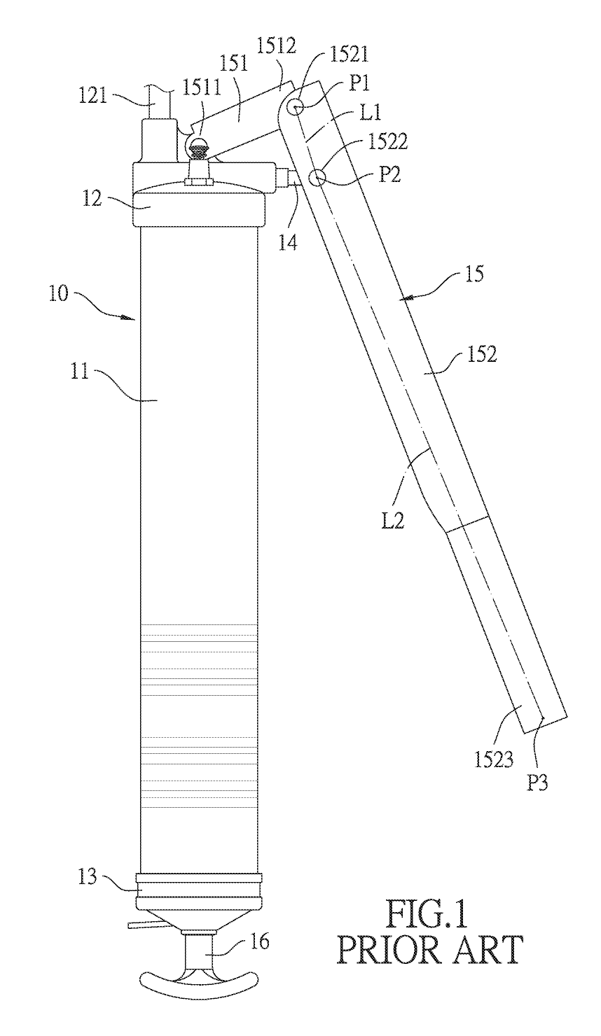

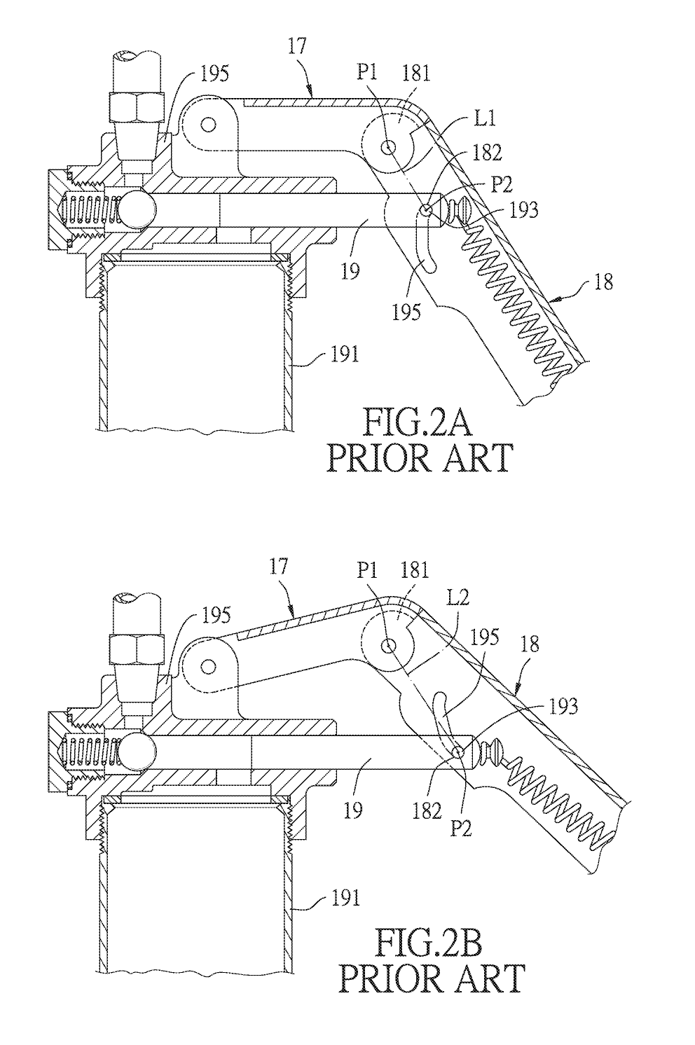

### DETAILED DESCRIPTION

The present invention will be clearer from the following description when viewed together with the accompanying drawings, which show, for purpose of illustrations only, the preferred embodiment in accordance with the present invention.

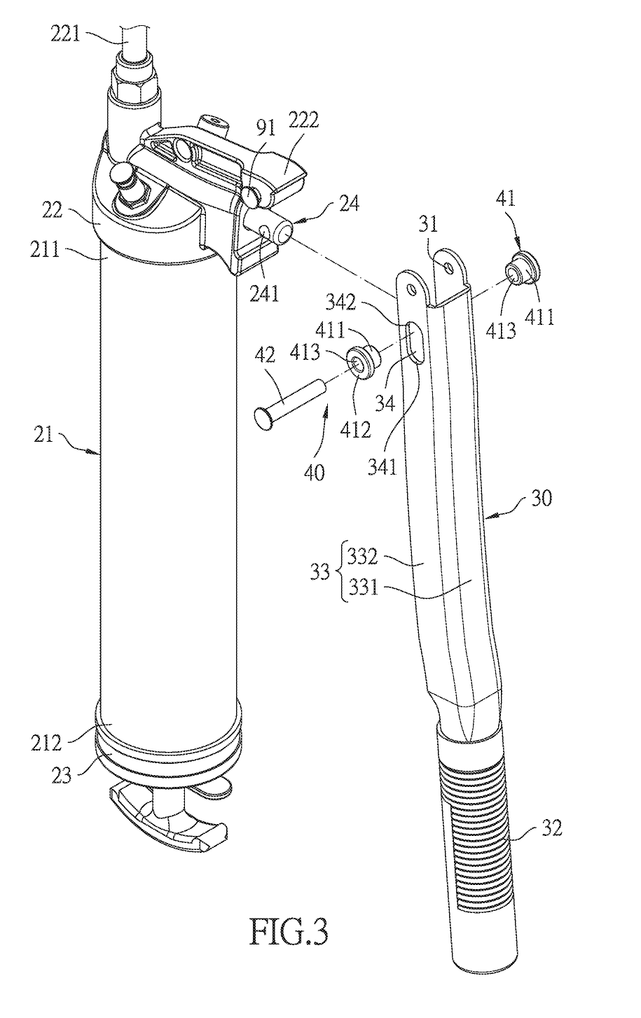

Referring to FIGS. 3-7, a lever type grease gun according to the present invention essentially comprises a hollow cylinder 21, a front-end cover 22, a back-end cover 23, an oil pushing rod 24, and a handle unit.

The hollow cylinder 21 has a first end 211 and a second end 212 opposite to the first end 211.

The front-end cover 22 is located at the first end 211 of the hollow cylinder 21 and provided with a nozzle part 221 and a mounting portion 222. It is worth mentioning that the mounting portion 222 is integrally formed in a fixed manner and cannot be pivoted or moved.

The back-end cover 23 is located at the second end 212 of the hollow cylinder 21.

The oil pushing rod 24 is disposed at the front-end cover 22, closer to the back-end cover 23 than the mounting portion 222, capable of moving in the front-end cover under push forces, and has an oil pushing rod part 241 located outside the front-end cover 22. In the embodiment, the oil pushing rod part 241 is configured as a through-hole. Since the oil pushing rod 24 is a known member and its actuation mode is also well known, so they are not the key creation points of the present invention, and no details will be provided for the actuation mode of this member herein.

The handle unit comprises a lever 30 and a connecting set 40.

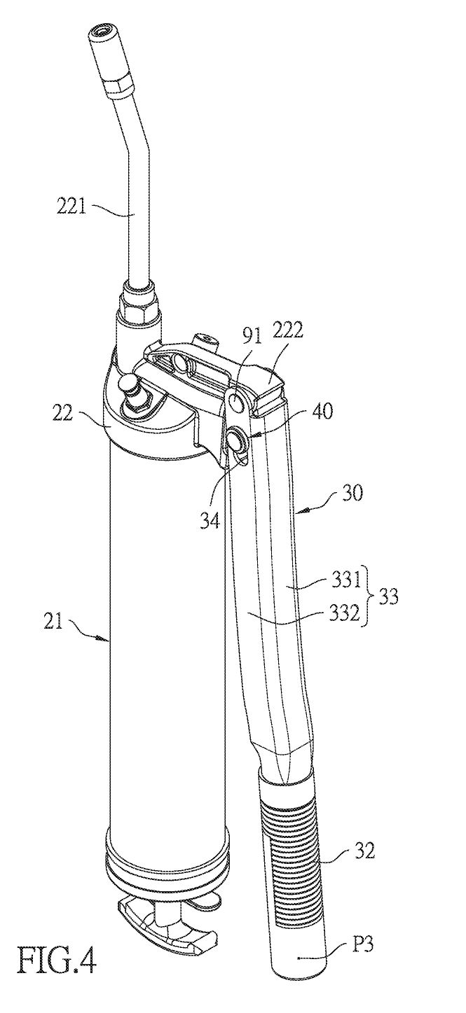

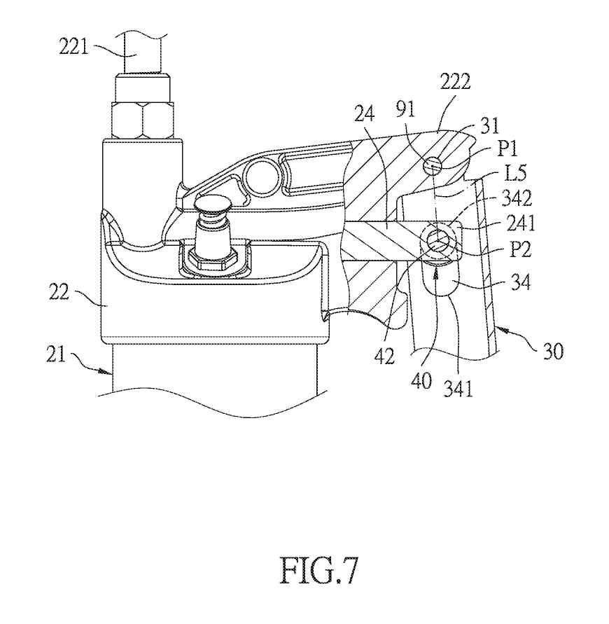

The lever 30 is mounted on the front-end cover 22 in a pressable manner, and can be pressed from a first position (a normal state, as shown in FIG. 5) toward a second position (the after-filling-oil state, as shown in FIG. 7). The lever 30 includes: a pivoting part 31 pivotally connected to the mounting portion 222, a pressing part 32, and a rod portion 33 between the pivoting part 31 and the pressing part 32. The rod portion 33 has a bottom surface 331 and two wing surfaces 332 respectively disposed on and connected to opposite sides of the bottom surface 331, and each of the wing surfaces 332 is provided with a straight slot 34 extending along the length of the lever 30 and having a first slot end 341 and a second slot end 342 which is closer to the pivoting part 31 than the first slot end 341. The straight slot 34 has an extension line 343 passing through the first and second slot ends 341, 342, and the extension line 343 is parallel to the bottom surface 331, that is, the extension line 343 has no common point and does not intersect with the bottom surface 331. In this embodiment, the pivoting part 31 in the form of a through hole which is pivoted at the mounting portion 222 of the front-end cover 22 by means of a through-going shaft 91, so that the lever 30 is pivoted at the front-end cover 22 and the pressing part 32 can move closer to and away from the hollow cylinder 21.

The connecting set 40 is connected to the oil pushing rod 24 and lever 30 as a pivot, inserted through the oil pushing rod part 241, and movably disposed in the straight slots 34, and can move closer to or away from the first slot end 341 and the second slot end 342.

In this embodiment, the connecting set 40 includes two connecting shaft sleeves 41 and a connecting pivot 42. The connecting shaft sleeves 41 are located in the straight slots 34 respectively, and each have a guiding part 411 inserted in the straight slot 34, an expansion part 412 connecting the guiding part 411 and located at the outer side of the edge of the straight slot 34, and a perforation part 413 running through the guiding part 411 and the expansion part 412. The connecting pivot 42 is inserted through the perforation parts 413 of the connecting shaft sleeves 41, the straight slots 34 and the oil pushing rod part 241, and is pivotally connected with the connecting shaft sleeves 41, the lever 30 and the oil pushing rod 24 through riveting.

As shown in FIG. 5, when the lever 30 is in the first position, the connecting set 40 is located at the first slot end 341, and as shown in FIG. 7, when the lever 30 is pushed to the second position, the connecting set 40 is moved to the second slot end 342. While the lever 30 is being pushed to move from the first position to the second position, the connecting set 40 is moved from the first slot end 341 to the second slot end 342, and the linear distance between the connecting set 40 and the pivoting part 31 gradually decreases.

The structure and configuration of the main members of the embodiment of the present invention are described above.

As shown in FIGS. 5-7, the present invention provides a lever type grease gun which has the straight slots 34 formed in the lever 30 of the handle unit, and the extension line of each of the straight slots 34 is parallel to the bottom surface 331. Besides, with the design that the connecting set 40 is inserted in the oil pushing rod part 241 and movable within the straight slots 34, the present invention provides a sliding connection between the oil pushing rod 24 and the lever 30 during pressing of the lever, that is, the distance between the pivoting part 31 of the lever 30 as the fulcrum P1 and the connecting set 40 as the resistance point P2 as well as the distance between the connecting set 40 as the resistance point P2 and the pressing part 32 of the lever 30 as the point of force application P3 will change before, during and after pressing of the lever 30, thus reducing the force required to fill the grease.

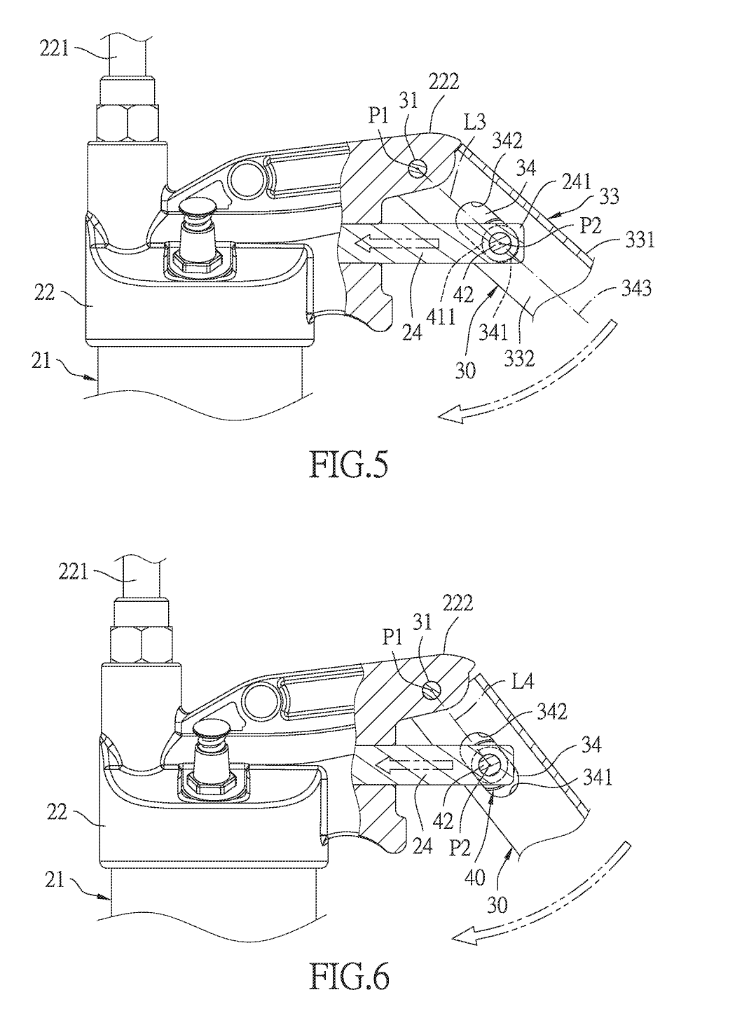

FIG. 5 shows the status of the present invention before pressing the lever. In this status, the distance between the pivoting part 31 of the lever 30 as the fulcrum P1 and the connecting set 40 as the resistance point P2 is assumed as L3. FIG. 6 shows the status of the present invention before and during pressing the lever. In this status, the distance between the pivoting part 31 of the lever 30 as the fulcrum P1 and the connecting set 40 as the resistance point P2 is assumed as L4. FIG. 7 shows the status of the present invention before and after pressing the lever. In this status, the distance between the pivoting part 31 of the lever 30 as the fulcrum P1 and the connecting set 40 as the resistance point P2 is assumed as L5. We can clearly know from FIGS. 5-7 that the distances L3, L4 and L5 (resistance arm) between the pivoting part 31 of the lever 30 as the fulcrum P1 and the connecting set 40 as the resistance point P2 are gradually decreasing before, during and after pressing the lever 30, so the force required on the lever 30 before, during and after pressing are also gradually decreasing, thus reducing the force required to fill the grease.

In addition, we can clearly know from FIGS. 5-7 that the distances L3, L4 and L5 (resistance arm) between the pivoting part 31 of the lever 30 as the fulcrum P1 and the connecting set 40 as the resistance point P2 are gradually decreasing before, during and after pressing the lever 30. From this, we can know that the distance (arm of force application) between the connecting set 40 as the resistance point P2 and the pressing part 32 of the lever 30 as the point of force application P3 is gradually increasing, thus further reducing the force required to fill the grease.

It should be noted that since the lever 30 and the front-end cover 22 are not connected through a non-fixed type connecting rod, that is, the lever 30 is directly pivoted at the mounting portion 222 of the front-end cover 22 by the pivoting part 31, which makes the pressing of the lever 30 relatively stable and the force of the oil pushing rod 24 relatively reliable.

While we have shown and described various embodiments in accordance with the present invention, it is clear to those skilled in the art that further embodiments may be made without departing from the scope of the present invention.

What is claimed is:

1. A lever type grease gun comprising:
a hollow cylinder, having a first end and a second end opposite to the first end;
a front-end cover, located at the first end of the hollow cylinder and provided with a nozzle part and a mounting portion;
a back-end cover located at the second end of the hollow cylinder;
an oil pushing rod disposed at the front-end cover, located closer to the back-end cover than the mounting portion, capable of moving in the front-end cover under push forces, and having an oil pushing rod part located outside the front-end cover; and
a handle unit comprising a lever and a connecting set, wherein the lever is mounted on the front end cover in a pressable manner, and capable of being pressed from a first position toward a second position, the lever includes: a pivoting part pivotally connected to the mounting portion, a pressing part, and a rod portion between the pivoting part and the pressing part, the rod portion has a bottom surface and a straight slot extending along a length of the lever and having a first slot end and a second slot end which is closer to the pivoting part than the first slot end, the straight slot has an extension line passing through the first and second slot ends, the extension line is parallel to the bottom surface; the connecting set is inserted through the oil pushing rod part, disposed in the straight slot and movable between the first slot end and the second slot end; when the lever is in the first position, the connecting set is located at the first slot end, when the lever is pushed to the second position, the connecting set is moved to the second slot end, while the lever is being pushed to move from the first position to the second position, the connecting set is moved from the first slot end to the second slot end, and a linear distance between the connecting set and the pivoting part gradually decreases.

2. The lever type grease gun as claimed in claim 1, wherein the rod portion further includes two wing surfaces respectively disposed on and connected to two opposite sides of the bottom surface, and each of the wing surfaces is provided with the straight slot, the connecting set includes two connecting shaft sleeves and a connecting pivot, the connecting shaft sleeves are located in the straight slot, and the connecting pivot is inserted through the connecting shaft sleeves, the straight slot and the oil pushing rod part.
